(19) United States
(12) Patent Application Publication
(10) Pub. No.: US 2019/0050603 A1
(43) Pub. Date: Feb. 14, 2019

(54) PROGRAMMABLE DEVICE AUTHENTICATION DECRYPTION

(71) Applicant: Intel Corporation, Santa Clara, CA (US)

(72) Inventors: Sean R. Atsatt, Santa Cruz, CA (US); Ting Lu, Austin, TX (US); James Ryan Kenny, San Jose, CA (US); Bruce B. Pedersen, Sunnyvale, CA (US); Robert Landon Pelt, Austin, TX (US); Andrew Martyn Draper, Chesham (GB)

(21) Appl. No.: 15/940,887

(22) Filed: Mar. 29, 2018

(51) Int. Cl. G06F 21/76; G06F 21/72; G06F 21/44; H04L 9/32; H04L 9/06

(52) U.S. Cl. CPC G06F 21/76; G06F 21/72; H04L 9/0631; H04L 9/3236; G06F 21/44

(57) ABSTRACT

Integrated circuit devices and methods include utilizing security features including authenticating incoming data by receiving one or more hash blocks each including multiple hash sub-blocks. Authenticating also includes receiving encrypted data including multiple data sub-blocks. Authenticating also includes authenticating a first hash block of the one or more hash blocks using a root hash of an integrated circuit device. Authenticating further includes authenticating each of the multiple data sub-blocks using a corresponding hash sub-block of the multiple hash sub-blocks.

### BACKGROUND

The present disclosure generally relates to integrated circuit (IC) devices and, more particularly, to performing authorized decryption of an integrated circuit device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Generally, an electronic device or an electrical system may include one or more IC devices. To improve operational flexibility, in some instances, an IC device may be a programmable logic device that is programmable (e.g., configurable) after manufacturing to provide one or more functions, such as a field programmable gate array (FPGA). To facilitate providing a function, an IC device may include one or more logic elements (e.g., blocks and/or gates), for example, programmed (e.g., configured) to operate based at least in part on corresponding configuration data.

As mentioned above, the programmable devices may be programmed with software that enables specific functions on the programmable devices. The software may be quite valuable, as the software may provide new and/or enhanced functionality for the programmable devices. Further, in some instances, it may be desirable to maintain secrecy of the functionality, especially for sensitive functions, such as military functionality and/or secure transactions. Accordingly, the product owners may wish to secure the programmable device.

IC devices may utilize decryption of data and key-based authentication of the data. Further, to improve security strength and mitigate differential power analysis vulnerability, an entire data set of the data may be authenticated before decryption. However, when the IC device is a programmable logic device, the full data set may be relatively large compared to memory local to the programmable logic device making such authentication impractical or impossible.

### SUMMARY

A summary of certain embodiments disclosed herein is set forth below. It should be understood that these aspects are presented merely to provide the reader with a brief summary of these certain embodiments and that these aspects are not intended to limit the scope of the present disclosure. Indeed, the present disclosure may encompass a variety of aspects that may not be set forth below.

The present disclosure generally relates to integrated circuit (IC) devices, which may operate to perform one or more target (e.g., desired) functions in an electrical system. The IC's may be protected by authenticating encryption keys for configuring programmable IC devices, such as Field Programmable Gate Arrays (FPGAs), which are ICs that include programmable logic and programmable routing.

A data stream may be chopped into smaller authenticated pre-sized portions (e.g., 4 kB) without storing the entire data stream in the configuration memory before authentication. By chopping the data into smaller portions that correspond to a hash block, the data may be authenticated using to avoid the amount of performance loss that may occur through using the configuration memory to at least temporarily store the unauthenticated/encrypted data before authentication or enlarging the internal buffer to an impractical size. Each smaller portion (e.g., data sub-block) of the data may be authenticated using a portion (e.g., hash sub-block) of a hash block. The first hash block may be authenticated using a root hash of the IC device, and the first hash block may authenticate a subsequent hash block. Similarly, the subsequent hash block may authenticate a hash block occurring after the subsequent hash block. In other words, the hash blocks may authenticate each other in a chain after the first hash block has been authenticated providing a practically limitless length of the data stream to be authenticated. Thus, the hash blocks provide a way to authenticate any length of data using a pre-determined size (e.g., 4 kB size of internal buffer) without subjecting the IC device to potential compromise or reducing performance due to storing the unauthenticated data in the configuration memory.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an electrical system including an integrated circuit (IC) device having a security sub-system, in accordance with an embodiment;

FIG. 2 is a block diagram of a logic element array included in the IC device of FIG. 1, in accordance with an embodiment;

FIG. 3 is a flow diagram of an authentication-decryption process that may be employed using the security sub-system of FIG. 1, in accordance with an embodiment;

FIG. 4 illustrates a block diagram of an embodiment of a key ladder that may be used in the security sub-system of FIG. 1, in accordance with an embodiment;

FIG. 5 is an authentication scheme that utilizes a sub-module root hash to authenticate a first hash block and each hash block to authenticate a next hash block, in accordance with an embodiment;

FIG. 6 is a flow diagram of an embodiment of a process that may be used to authenticate using the authentication scheme of FIG. 5, in accordance with an embodiment;

FIG. 7 is a flow diagram of an embodiment of a process for authenticating the hash blocks of FIG. 5, in accordance with an embodiment;

FIG. 8 is a flow diagram of an embodiment of a process for decrypting and authenticating ciphertext including data corresponding to the hash blocks of FIG. 5, in accordance with an embodiment;

FIG. 9 is a schematic diagram of authentication/decryption circuitry used to implement the processes of FIGS. 6-9, in accordance with an embodiment; and

FIG. 10 is a block diagram of a data processing system comprising the integrated circuit device of FIG. 1, in accordance with an embodiment.

### DETAILED DESCRIPTION

One or more specific embodiments will be described below. In an effort to provide a concise description of these embodiments, not all features of an actual implementation are described in the specification. It may be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it may be appreciated that such a development effort might be complex and time consuming, but would nevertheless be a routine undertaking of design, fabrication, and manufacture for those of ordinary skill having the benefit of this disclosure.

Generally, a programmable logic device, such as a field-programmable gate array (FPGA), operates to provide one or more functions in an electrical system. For example, the functions may include combinational functions, sequential functions, arithmetic functions, logic functions, and/or custom function. Thus, in some embodiments, the programmable logic device may operate to process data, analyze data, store data, and/or read data. Furthermore, as previously noted, these functions, as stored in configuration data, may be authorized and/or decrypted before being implemented in the device. Historically, programmable logic devices may rely on a simple advanced encryption standard (AES) engine to provide both confidentiality and authenticity protection. Due to limitations of the AES algorithm and it potential vulnerability to emerging side channel attacks, other algorithms may instead be used to provide strong authentication and confidentiality. For example, in some embodiments, all of the data of a configuration bitstream may be authenticated first using either public-key-based algorithm such as elliptic curve digital signature algorithm (ECDSA).

If data successfully passes the public-key-based algorithm authentication, data will be pushed through the AES engine for decryption. By authenticating with a public key before the AES engine, a likelihood of success differential power analysis (DPA) attacks is reduced by leveraging the public-key-based algorithm. Additionally, front-end key-based authentication engine at least partially protects the AES engine from side channel attacks, removes randomly chosen encrypted text attack threats, and significantly reduces power traces collectable by potential attackers. Furthermore, such a configuration may be used to enable parts of the configuration data to be loaded in any order and/or to be reloaded without restarting configuration from the beginning of a configuration process. However, such a configuration may utilize an intermediate buffer to hold the full data set (e.g., all configuration data) in the programmable logic device. This full data set may be large (e.g., up to 100 MB). It may be impossible or impractical to add an internal buffer to hold the full data set within the programmable logic device before authentication/decryption.

Configuration memory may be used to store authenticated configuration data in the programmable logic device. However, using configuration memory within programmable logic device to store the data before authorization and/or decryption may cause vulnerabilities in the programmable logic device. To account for this, special protection would be needed to avoid damage to the silicon and to avoid generating an excessive power spike. Furthermore, storing this data in the configuration memory would require the data to be looped back from the configuration memory to the AES engine. This loopback causes the data to be passed through the configuration bus three times: 1) to the configuration memory as unauthenticated/decrypted data, 2) back to the AES engine to authenticate/decrypt, and 3) back to the configuration memory as authenticated/decrypted data. Thus, this loopback may triple delays in finally moving the incoming data to the configuration memory.

Instead of using the configuration memory as the internal buffer, the data stream may be chopped into smaller authenticated pre-sized portions (e.g., 4 kB) or block chains without storing the entire data stream in the configuration memory before authentication. By chopping the data into smaller portions that correspond to a hash block, the data may be authenticated using to avoid the amount of performance loss that may occur through using the configuration memory to at least temporarily store the unauthenticated/encrypted data before authentication. Each smaller portion (e.g., data sub-block) of the data may be authenticated using a portion (e.g., hash sub-block) of a hash block. The first hash block may authenticate with a root hash of the IC device, and the first hash block may authenticate a subsequent hash block. Similarly, the subsequent hash block may authenticate a hash block occurring after the subsequent hash block. In other words, the hash blocks may authenticate each other in a chain after the first hash block has been authenticated. Thus, the hash blocks provide a way to authenticate the data at a pre-determined size (e.g., 4 kB) without subjecting the IC device to potential compromise or reducing performance due to storing the unauthenticated data in the configuration memory.

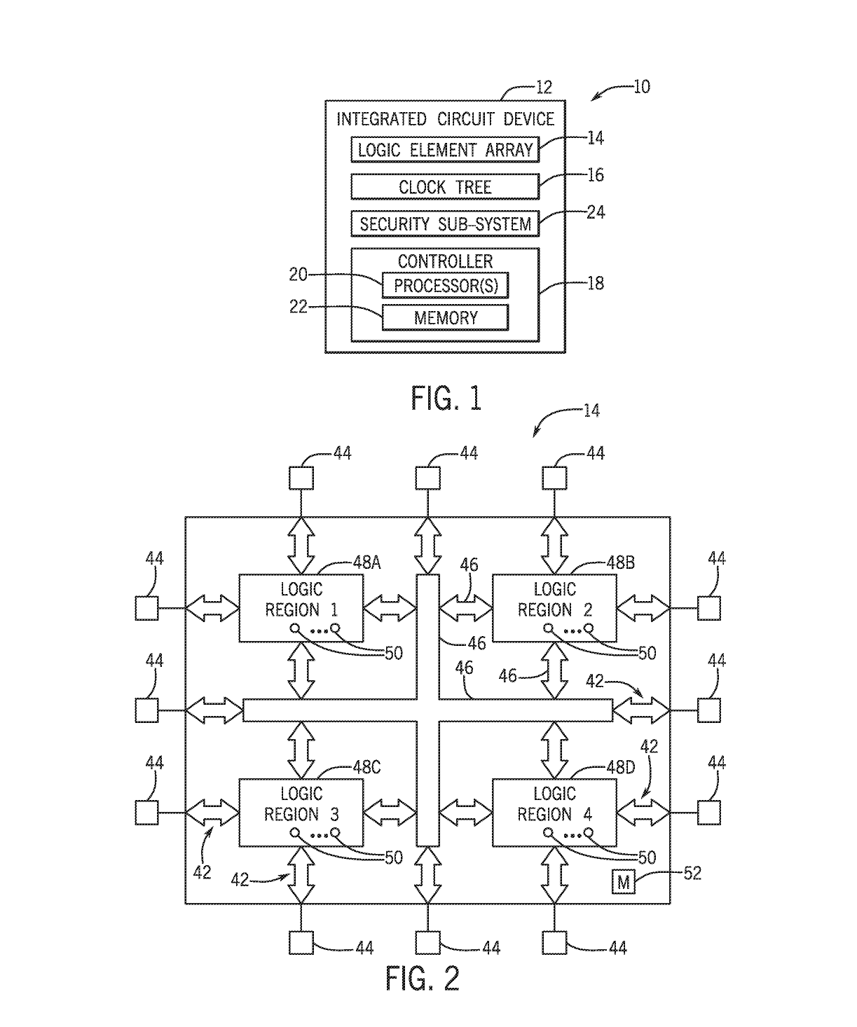

To help illustrate, one embodiment of an electrical system 10 including an IC device 12 is shown in FIG. 1. In some embodiments, the electrical system 10 may be included in an industrial system, a manufacturing system, an automation system, or the like, such as a factory or plant. Additionally, in some embodiments, the electrical system 10 may be included in an electronic device, such as a handheld computing device, a tablet computing device, a notebook computer, a desktop computer, or the like. Furthermore, in some embodiments, electrical system 10 may be included in an automotive system, such as an airplane, boat, or car.

Thus, although one IC device 12 is depicted, it should be appreciated that this is merely intended to be illustrative and not limiting. In other words, in other embodiments, the electrical system 10 may include multiple IC devices 12. For example, the electrical system 10 may include a first IC device 12 (e.g., central processing unit or graphics processing unit) communicatively coupled with a second IC device 12 (e.g., random-access memory).

In any case, as depicted, the IC device 12 includes a logic element array 14, a clock tree 16, and a controller 18. In some embodiments, the controller 18 may control operation of the logic element array 14 and/or the clock tree 16. To facilitate controlling operation, the controller 18 may include a processor 20 and memory 22. In some embodiments, the controller 18 may control operation based at least in part on circuit connections (e.g., logic gates) formed in the controller 18.

Additionally or alternatively, the processor 20 may execute instructions stored in the memory 22. Thus, in some embodiments, the processor 20 may include one or more general purpose microprocessors, one or more application specific processors (ASICs), one or more field programmable logic arrays (FPGAs), and/or the like. Additionally, in some embodiments, the memory 22 may include one or more tangible, non-transitory, computer-readable mediums. For example, the memory 22 may include random access memory (RAM), read only memory (ROM), rewritable non-volatile memory, such as flash memory, hard drives, optical discs, and/or the like.

The IC device 12 may operate to perform one or more functions in the electrical system 10. To facilitate providing a function, the logic element array 14 may include communicatively coupled logic elements (e.g., gates) that operate to perform combinational functions, sequential functions, arithmetic functions, logic functions, and/or custom functions. Additionally, in some embodiments, the logic element array 14 may be divided into one or more logic regions, which each includes one or more logic elements.

The IC device 12 may also include a security sub-system 24 that is used to secure the IC device 12. For example, as will be discussed in more detail below, the security sub-system 24 may be used to encrypt, authenticate, and/or decrypt configuration data for the logic element array.

One embodiment of a logic element array 14 organized into multiple logic regions 48 is shown in FIG. 2. In particular, the depicted embodiment includes a first logic region 48A, a second logic region 48B, a third logic region 48C, and a fourth logic region 48D, which each includes one or more logic elements 50. In some embodiments, a logic element 50 may include one or more muxes, one or more flip-flops, one or more logic gates, one or more logic blocks, one or more look-up-tables, and/or one or more registers.

In some embodiments, the logic element array 14 may be organized such that different logic regions 48 operate to perform different functions. Additionally or alternatively, the logic element array 14 may be organized such that multiple logic regions 48 cooperate to perform a single function. Thus, to facilitate proper operation of the IC device 12, operation of different logic regions 48 may be coordinated (e.g., synchronized) and/or data communication may be provided.

To facilitate data communication, the logic element array 14 may include input/output circuitry 42, input/output pins 44, and an internal communication network 46 (e.g., a network-on-chip). In some embodiments, the input/output circuitry 42 may facilitate external data communication via the input/output pins 44, for example, between the logic element array 14 and another IC device 12. Additionally, in some embodiments, internal communication network 46 may facilitate internal data communication, for example, between logic regions 48 and/or with input/output circuitry 42. Thus, in some embodiments, the internal communication network 46 may include interconnects, such as conductive lines and/or busses. Furthermore, in some embodiments, the internal communication network 46 may include fixed interconnects and/or programmable interconnects.

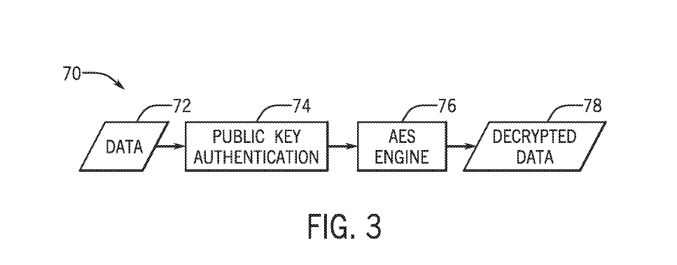

Turning now to the authentication and decryption of data incoming to the IC device 12 using the security sub-system 24. FIG. 3 is a flow diagram of an authentication-decryption process 70 that may be employed using the security sub-system 24. The IC device 12 receives data 72. The received data 72 may include configuration data that is used to configure the logic element array 14. In some embodiments, the received data 72 may include a hashed version of the configuration data. The data 72 undergoes public-key-based authentication 74 before being passed to an AES engine 76 to decrypt the data 72 as decrypted data 78. As appreciated, the public-key-based authentication 74 utilizes a key to verify that the data 72 should be passed to the AES engine 76 thereby at least partially protecting the AES engine 76 from potential side attacks. The AES engine 76 then may be used to decrypt the data 72 with increased security due to the presence of the public-key-based authentication 74.

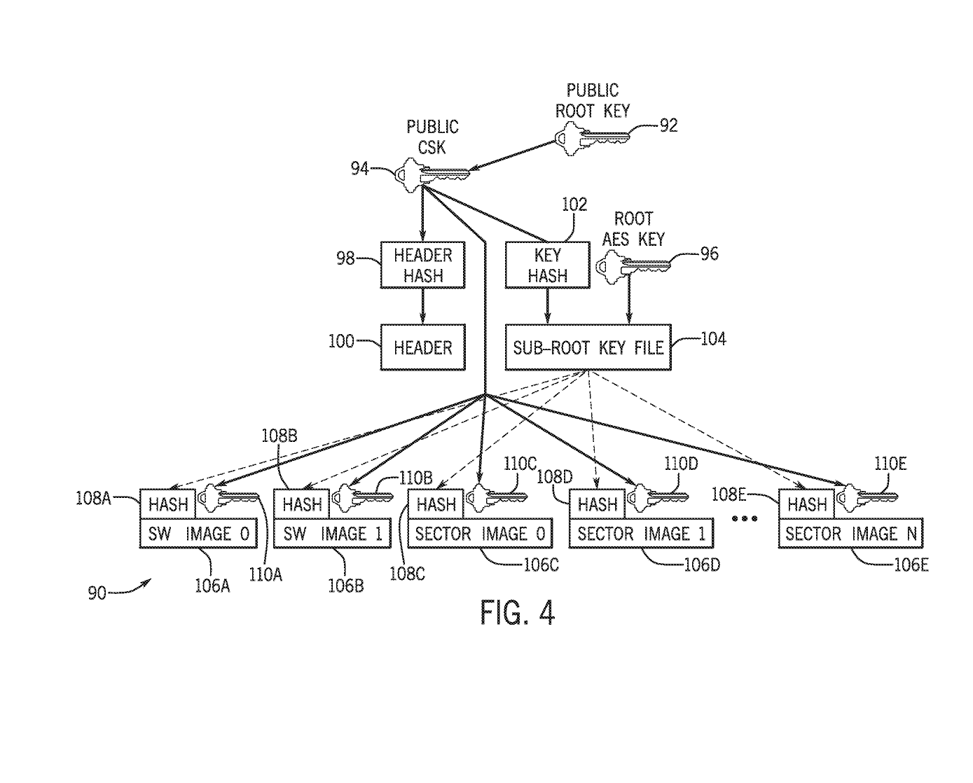

In some embodiments, to enable the process 70, a key ladder may be used. FIG. 4 illustrates a block diagram of an embodiment of a key ladder 90. The key ladder 90 includes a non-mutable public root key 92 stored (e.g., pre-installed at manufacture) in the IC device 12. The public root key 92 is used to create a public code shifted keying (CSK) key 94. The IC device 12 may also store (e.g., pre-installed at manufacture) a root AES key 96. The public CSK key 94 may be used to generate a header hash 98 for a header 100 for the data 72 (e.g., configuration data). The public CSK key 94 may also be used to generate a key hash 102 that is used along with the root AES key 96 to generate a signing key. The signing key is used to verify the header 100 and portions of a sub-root key file 104 that includes hash digests of hashed data 108 corresponding to a respective data sub-block 106 of the data 72. The sub-root key file 104 also includes encrypted sub-root keys 110 (e.g., AES key) each corresponding to a respective data sub-block 106. Since the sub-root key file 104 and the header 100 are small, they may be stored within the internal memory space and can be verified using public key algorithms.

Thus, during an authentication operation, one sub-root hash digest is authenticated for each data sub-block 106 used in the authentication operation (e.g., the header 100). Similarly, during a confidential authentication of the entire data 72, one sub-root hash digest and one sub-root key 110 is authenticated for each data sub-block 106. An authentication/decryption operation may utilize one sub-root hash digest and one sub-root AES key. Data block. However, as previously noted, the total data size of the data 72 may be much bigger than an available internal buffer. To address this issue, the data 72 may be split into fixed-size (e.g., 4 kB) data blocks. The size of the data sub-blocks 106 may be any size based on an amount of internal first-in, first-out (FIFO) buffer available.

Each configuration data set in the data 72 has one root hash value which is a hash used to authenticated a first 4K hash block of configuration data. Each hash block contains hashes of multiple data sub-blocks 106 with a last position of the hash block reserved to authenticate a next hash block. Each of the rest of the positions may be populated with the hashes of respective data sub-blocks to authenticate the data 72. If the hashed versions of the data sub-blocks 106 takes up more space than is available in the hash block, a last hash data block will be replaced with a hash digest block for a next hash block. Thus, the hash blocks may be chained together for as many hash blocks are used to account for the entire data 72 being authenticated/decrypted.

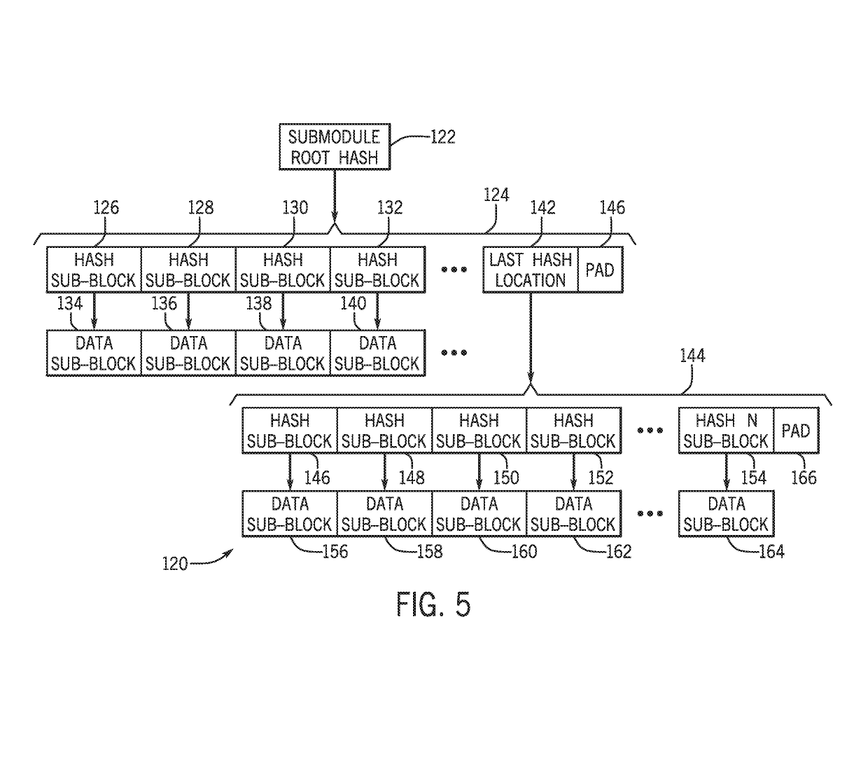

FIG. 5 is an authentication scheme 120 that utilizes a sub-module root hash 122 to authenticate a first hash block 124. In some embodiments, the sub-module 1 hash 122 may be located in the sub-root key file 104. As illustrated the hash block 124 includes hash sub-blocks 126, 128, 130, and 132. The hash sub-blocks 126, 128, 130, and 132 may each be used to authenticate corresponding data sub-blocks 134, 136, 138, and 140 in the data 72. The size and/or number of the hash sub-blocks included in the hash block 124 may depend upon a size of the data sub-blocks being authenticated and an amount of space available for the hash block 124. In some embodiments, a pre-determined size (e.g., 4 kB). For the hash block 124 may be the same as the size used for the pre-determined size of the data sub-blocks 134, 136, 138, and 140. A last hash location 142 of the hash block 124 may be reserved for a has used to authenticate a subsequent hash block 144 when the amount of data in the data 72 exceeds an amount of data that may be authenticated using only the hash block 124. The hash block 124 may also include a pad 145 that pads a remaining size of the hash block 124 beyond the hash blocks included therein to achieve a pre-determined size (e.g., 4 kB) for the hash block 124.

Further, as illustrated, the hash block 144 includes hash blocks 146, 148, 150, 152, and 154. These hash blocks 146, 148, 150, 152, and 154 may each be used to authenticate a respective data sub-block 156, 158, 160, 162, and 164. Since no additional data is to be authenticated in the data 72 the hash block 154 may be used to authenticate the data sub-block 164 rather than being used to authenticate a separate hash block. The hash block 144 may also include a pad 166 that pads a remaining size of the hash block 144 beyond the hash blocks included therein to achieve a pre-determined size (e.g., 4 kB) for the hash block 144.

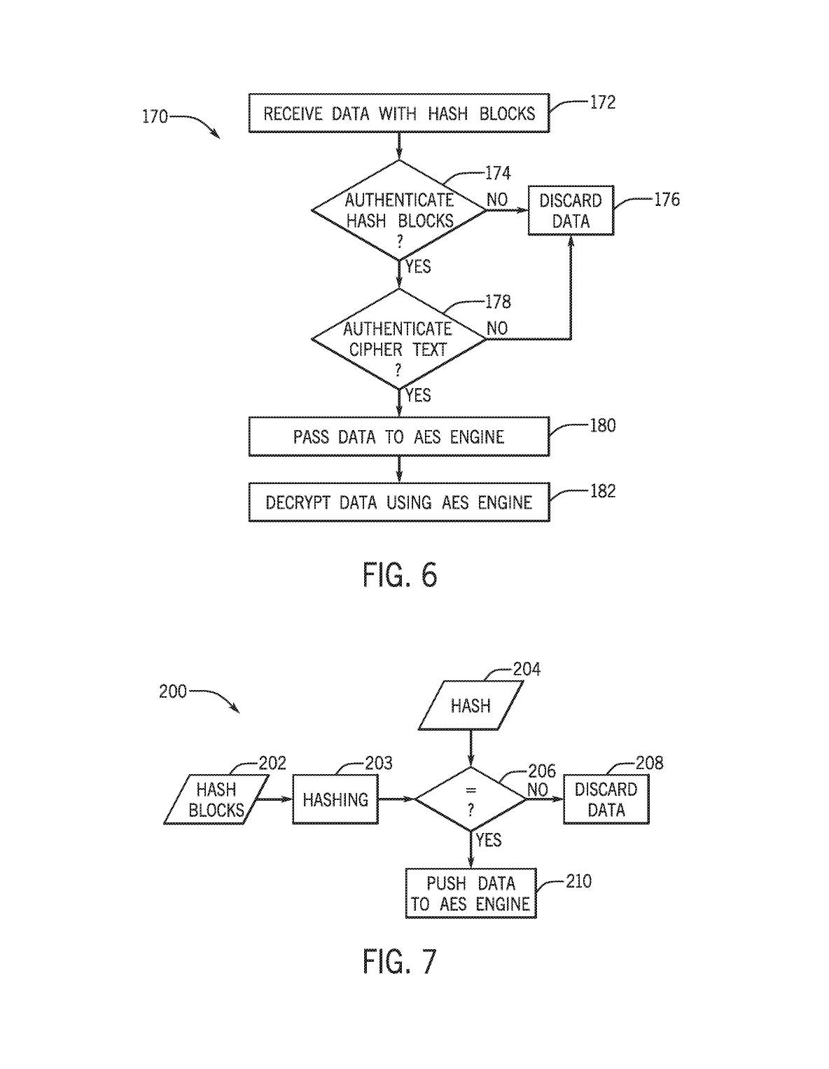

FIG. 6 is a flow diagram of an embodiment of a process 170 that may be used to authenticate using the authentication scheme 120. The process 170 includes receiving the data 72 with hash blocks (block 172). Receiving the data may include initiating a configuration process to receive the data 72 as configuration data for configuring the logic element array 14. The data and the hash blocks may be received separately and/or in a single package. The IC device 12 determines whether the hash blocks are authenticated (block 174). For example, as discussed below in relation to FIG. 7, the IC device 12 may hash the hash blocks and compare them to a hash stored in the IC device. If the hash blocks are not authenticated, the IC device 12 discards the data 72 (block 176). In embodiments where receiving the data is part of a configuration process for the logic element array, discarding the data may include halting the configuration process.

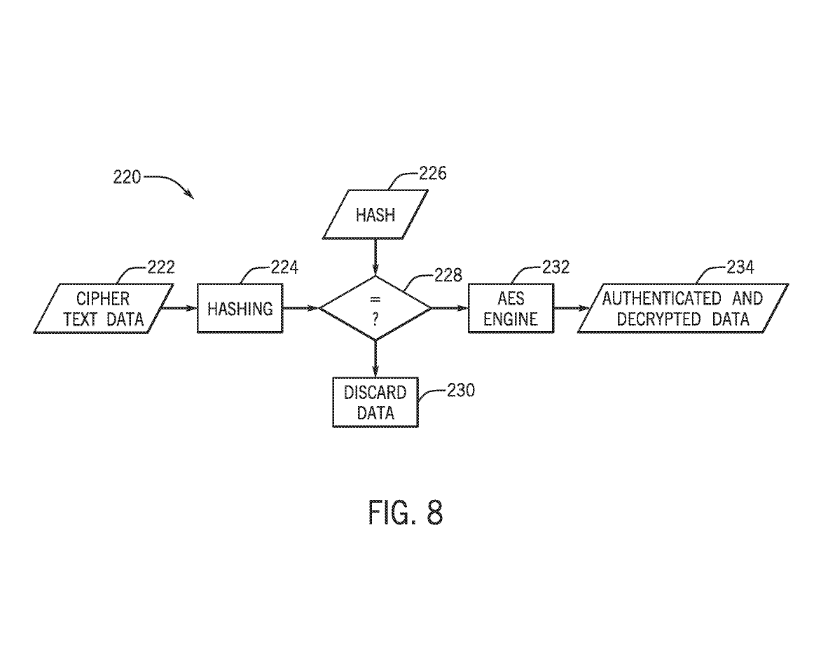

In some embodiments, the IC device 12 may also determine whether ciphertext of the data is authenticated as well (block 178). For example, as discussed below in relation to FIG. 8, the IC device 12 may hash the ciphertext including the data and compare the hashed ciphertext to a hash stored in the IC device 12. If the ciphertext is not authenticated, the IC device may discard the data 72. If the ciphertext and the hash blocks are authenticated, the data 72 is passed to the AES engine 76 (block 180). The AES engine 76 decrypts the data into decrypted data (block 182).

FIG. 7 is a flow diagram of an embodiment of a process 700 for authenticating the hash blocks. The IC device 12 receives hash blocks 202, such as hash block 124 and hash block 144. The hash blocks 202 are hashed (block 203). For example, the hashing may utilize a secure hashing algorithm (SHA), such as SHA-2 or SHA-3, to hash the hash blocks 202. For instance, the hashing algorithm may include SHA256/384 and/or any other hashing algorithms suitable for cryptographically hashing data.

The IC device 12 then compares the hashed version of the hash blocks 202 to a hash 204 (block 206). For example, the hash 204 may be the sub-module root hash 122 for a first hash block (e.g., hash block 124), but the hash 204 may be a hash sub-block (e.g., hash sub-block 142) may be the hash for a subsequent hash block (e.g., hash block 144). Thus, the hash blocks may sequentially authenticate each other in a chain where the hash 204 for each hash block is a part (e.g., last hash sub-block) from a previous hash block after the first hash block has been authenticated from the root hash. If the hash 204 does not match the hashed version of the hash blocks 202, the IC device 12 discards the data including the hash blocks (block 208). If the hash 204 matches the hatched version of the hash blocks 202, the IC device 12 pushes the data to the AES engine 76 (block 210).

FIG. 8 is a flow diagram of an embodiment of a process 220 for decrypting and authenticating ciphertext 222 including the data 72. For example, the ciphertext 222 may include configuration data for configuring the logic element array 14. The IC device 12 receives the ciphertext 222 and hashes the ciphertext 222 (block 224). For example, the hashing may utilize a secure hashing algorithm (SHA), such as SHA-2 or SHA-3, to hash the hash blocks 202. For instance, the hashing algorithm may include SHA256/384 and/or any other hashing algorithms suitable for cryptographically hashing data.

The IC device 12 then compares the hashed version of the ciphertext 222 to a hash 226 (block 206). For example, the hash 226 may be a corresponding hash sub-block (e.g., hash sub-block 126). If the hash 204 does not match the hashed version of the hash blocks 202, the IC device 12 discards the data including the hash blocks (block 208). If the hash 204 matches the hatched version of the hash blocks 202, the IC device 12 pushes the data to the AES engine 76 (block 210). Thus, the encrypted data may be passed as the ciphertext 222 sequentially in data sub-blocks that enable authentication without storing the data in the memory 22 leading to potential compromise of the IC device 12 and/or introducing performance loss into the IC device 12. Furthermore, by passing the ciphertext 222 in smaller sub-blocks that are smaller than the whole data set, a practical size (e.g., 4 kB) of an internal buffer may be used rather than an impractically large internal buffer for an FPGA.

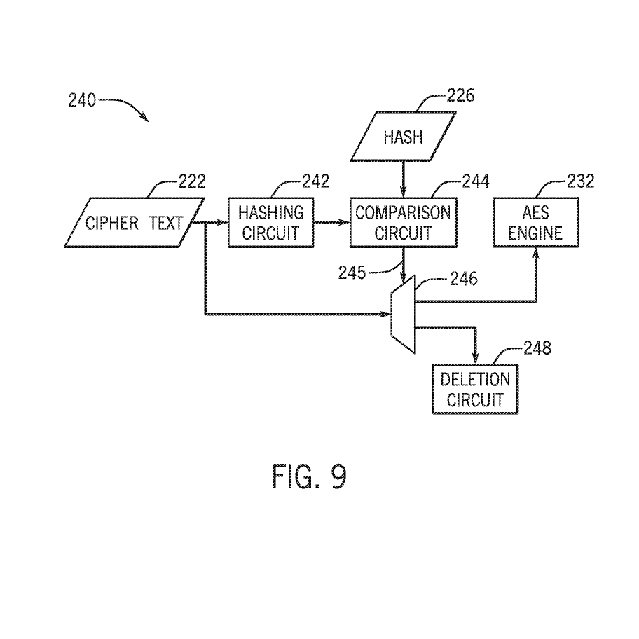

FIG. 9 is a schematic diagram of authentication/decryption circuitry 240. Ciphertext 222 is received at the authentication/decryption circuitry 240. The ciphertext 222 may include the data 72 and/or the hash blocks 202. As previously noted, each hash sub-block of each of the hash blocks 202 may be used to authenticate data sub-blocks of the data 72. Where the hash sub-blocks and the data sub-blocks may have an equal length (e.g., 4 kB). For example, this size may be set to a length of an internal buffer of the IC device 12. The hash blocks 202 and the data are submitted to a hashing circuit 242 that is used to hash at least the hash blocks 202. The hashed portions (e.g., hash blocks 202) of the ciphertext 222 are passed to a comparison circuit 244 that compares the hashed portions to a corresponding hash 226. For example, the hash 226 may be a root hash for a first hash block, a hash sub-block for subsequent hash blocks, and a hash sub-block for encrypted data sub-blocks. In some embodiments, the hashing circuit 242 and/or the comparison circuit 244 may be at least partially embodied in the processor(s) 20 and/or the memory 22. In other words, in some embodiments, the functionality of the hashing circuit 242 and/or the comparison circuit 244 may be performed using instructions stored in the memory 22 and executed by the processor(s) 20.

When the comparison circuit 244 has compared the hashed portion of the ciphertext 222 to the hash 226, the comparison circuit 244 outputs a control signal 245 that controls selection circuit 246 that selectively directs the ciphertext 222 to a deletion circuit 248 or to the AES engine 232. In the illustrated embodiment, the selection circuit 246 includes a demultiplexer. The deletion circuit 248 may discard the incoming ciphertext 222 to prevent it from being stored on the IC device 12 to prevent damage and/or compromise of the IC device 12. In some embodiments, the deletion circuit 248 and/or the AES engine 232 may be at least partially rely on and/or utilize instructions stored in the memory 22 and executed by the processor(s) 20.

In summary, each of the hash sub-blocks of each of the hash blocks 202, once authenticated, may be used to authenticate a corresponding data sub-block of the data 72 in the ciphertext 222 until all of the data 72 has been authenticated. Each sub-block of the data 72 may be decrypted in the AES engine 232 after its corresponding hash sub-block has authenticated its contents.

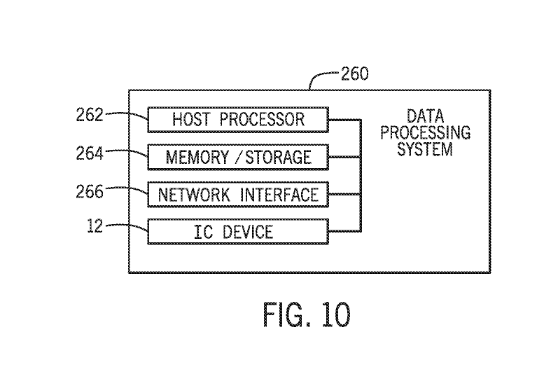

The IC device 12 may be, or may be a component of, a data processing system. For example, the IC device 12 may be a component of a data processing system 260, shown in FIG. 10. The data processing system 260 includes a host processor 262, memory and/or storage circuitry 264, and a network interface 266. The data processing system 260 may include more or fewer components (e.g., electronic display, user interface structures, application specific integrated circuits (ASICs)). The host processor 262 may include any suitable processor, such as an INTEL® XEON® processor or a reduced-instruction processor (e.g., a reduced instruction set computer (RISC), an Advanced RISC Machine (ARM) processor) that may manage a data processing request for the data processing system 260 (e.g., to perform machine learning, video processing, voice recognition, image recognition, data compression, database search ranking, bioinformatics, network security pattern identification, spatial navigation, or the like). Additionally or alternatively, the host processor 262 may include a field-programmable gate array (FPGA) and/or other programmable logic device. In some embodiments, the host processor 262 may be a programmable logic device that is distinct from the IC device 12, may be the same programmable logic device including the logic element array 14 of the IC device 12, may be a hardened central processing unit (e.g., processor(s) 29) within the IC device 12, and/or another suitable processor internal to and/or external to the IC device 12. The memory and/or storage circuitry 264 may include random access memory (RAM), read-only memory (ROM), one or more hard drives, flash memory, or the like. The memory and/or storage circuitry 264 may be considered external memory to the IC device 12, and may hold data to be processed by the data processing system 260. In some cases where the IC device 12 includes a programmable logic device, the memory and/or storage circuitry 264 may also store configuration programs (bitstreams) for programming the programmable logic device. The network interface 266 may allow the data processing system 260 to communicate with other electronic devices. The data processing system 260 may include several different packages or may be contained within a single package on a single package substrate.

Moreover, in some embodiments, the data processing system 260 may be part of a data center that processes a variety of different requests. For instance, the data processing system 260 may receive a data processing request via the network interface 266 to perform machine learning, video processing, voice recognition, image recognition, data compression, database search ranking, bioinformatics, network security pattern identification, spatial navigation, or some other specialized task. The host processor 262 may cause the programmable logic fabric and/or other portions of the IC device 12 to be programmed with a particular accelerator related to requested task or to store memory related to the requested task. For instance, the host processor 262 may instruct that configuration data (bitstream) stored on the memory and/or storage circuitry 264 or cached in sector-aligned memory of the IC device 12 to be programmed into the programmable logic fabric of the IC device 12.

The methods and devices of this disclosure may be incorporated into any suitable circuit. For example, the methods and devices may be incorporated into numerous types of devices such as microprocessors or other integrated circuits. Exemplary integrated circuits include programmable array logic (PAL), programmable logic arrays (PLAs), field programmable logic arrays (FPLAs), electrically programmable logic devices (EPLDs), electrically erasable programmable logic devices (EEPLDs), logic cell arrays (LCAs), field programmable gate arrays (FPGAs), application specific standard products (ASSPs), application specific integrated circuits (ASICs), and microprocessors, just to name a few.

Moreover, while the process operations have been described in a specific order, it should be understood that other operations may be performed in between described operations, described operations may be adjusted so that they occur at slightly different times or described operations may be distributed in a system which allows the occurrence of the processing operations at various intervals associated with the processing, as long as the processing of overlying operations is performed as desired.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

While the embodiments set forth in the present disclosure may be susceptible to various modifications and alternative forms, specific embodiments have been shown by way of example in the drawings and have been described in detail herein. However, it may be understood that the disclosure is not intended to be limited to the particular forms disclosed. The disclosure is to cover all modifications, equivalents, and alternatives falling within the spirit and scope of the disclosure as defined by the following appended claims.

What is claimed is:

1. An integrated circuit device, comprising:
a hashing circuit that receives a hash block and hashes the hash block to generate a hashed hash block, wherein each hash block comprises a sub hash-block that authenticates a data sub-block of encrypted data to be authenticated for the integrated circuit device;
a comparison circuit that compares the hashed hash block to an authentication root hash of the integrated circuit device and to generate a control signal based at least in part on the comparison;
selection circuit receives the encrypted data and to select whether to route the encrypted data to a decryption engine based at least in part on the control signal; and
a decryption engine decrypts the encrypted data based at least in part on the comparison.

2. The integrated circuit device of claim 1, wherein the integrated circuit device comprises a programmable logic device.

3. The integrated circuit device of claim 2, wherein the programmable logic device comprises a field-programmable gate array.

4. The integrated circuit device of claim 2, wherein the encrypted data comprises configuration data that configures a programmable logic element array of the programmable logic device.

5. The integrated circuit device of claim 1, wherein a last hash sub-block of the hash block authenticates a next hash block.

6. The integrated circuit device of claim 5, wherein the comparison circuit compares the next hash block to the last hash sub-block.

7. The integrated circuit device of claim 5, wherein the hash block comprises a pad after the last hash sub-block to cause the hash block to have a pre-determined size.

8. The integrated circuit device of claim 1, wherein the selection circuit discards the encrypted data when the control signal indicates that the hashed hash block does not match the authentication root hash of the integrated circuit device.

9. The integrated circuit device of claim 1, wherein the decryption engine comprises an Advanced Encryption Standard (AES) engine that uses an AES key to decrypt the encrypted data.

10. The integrated circuit device of claim 1, wherein the data sub-block has a same size as the hash block.

11. The integrated circuit device of claim 1, wherein the selection circuit comprises a demultiplexer.

12. The integrated circuit device of claim 1, wherein the hashing circuit hashes a first data sub-block of the encrypted data as a hashed data sub-block.

13. The integrated circuit device of claim 12, wherein the comparison circuit compares the hashed data sub-block to a corresponding hash sub-block of the hash block to authenticate the data sub-block.

14. The integrated circuit device of claim 13, wherein the encrypted data is discarded when the hashed data sub-block does not match the corresponding hash sub-block.

15. A method comprising:
receiving one or more hash blocks each comprising a plurality of hash sub-blocks;
receiving encrypted data comprising a plurality of data sub-blocks;
authenticating a first hash block of the one or more hash blocks using a root hash of an integrated circuit device; and
authenticating each of the plurality of data sub-blocks using a corresponding hash sub-block of the plurality of hash sub-blocks.

16. The method of claim 15, comprising authenticating a second hash block of the one or more hash blocks using a last hash sub-block of the first hash block.

17. The method of claim 15, wherein the encrypted data comprises configuration data for a logic element array of the integrated circuit device.

18. A data processing system comprising:
an integrated circuit device, comprising:
a programmable logic element array;
a hashing circuit that receives a plurality of hash blocks and sequentially hashes the plurality of hash blocks to generate a plurality of hashed hash blocks, wherein each hash block comprises a sub hash-block that authenticates a data sub-block of encrypted data to be authenticated for the integrated circuit device, wherein the encrypted data comprises configuration data to configure the programmable logic element array;
a comparison circuit that sequentially compares each of the plurality of hashed hash blocks to a corresponding authentication hash of a plurality of authentication hashes to generate a control signal based at least in part on the comparison, wherein a first authentication hash of the plurality of authentication hashes used to authenticate a first hash block of the plurality of hash blocks comprises a root hash of the integrated circuit device, and a second authentication hash of the plurality of authentication hashes used to authenticate a second hash block of the plurality of hash blocks comprises a last sub-block of the first hash block;
selection circuit receives the encrypted data and to select whether to route the encrypted data to a decryption engine based at least in part on the control signal; and
a decryption engine decrypts the encrypted data based at least in part on the comparison.

19. The data processing system of claim 18, comprising central processing unit device coupled to the integrated circuit device.

20. The data processing system of claim 19 comprising a data center comprising the integrated circuit device.
